(19) United States
(12) Patent Application Publication
(10) Pub. No.: US 2009/0259620 A1
(43) Pub. Date: Oct. 15, 2009

(54) Method and system for real-time data searches

(76) Inventors: Nii A. Ahene, Union City, CA (US); Eric J. Farraro, Santa Clara, CA (US); Praveen K. Jayaraman, Santa Clara, CA (US); John Tapley, San Jose, CA (US)

Correspondence Address: SCHWEGMAN, LUNDBERG & WOESSNER/EBAY, P.O. BOX 2938, MINNEAPOLIS, MN, 55402, US

(21) Appl. No.: 12/082,565

(22) Filed: Apr. 11, 2008

(51) Int. Cl. G06F 17/30

(52) U.S. Cl. 707/3; 707/E17.001

(57) ABSTRACT

Methods and system for real-time data searches are described. In one embodiment, time period news data may be received from a media source. A topical attribute associated with the time period news data may be obtained. A search request for data from a target data source may be received. The search request may include request criterion. The search request may be processed using the request criterion and the topical attribute to obtain result data. The result data may be provided from the target data source.

### BACKGROUND

Users seeking to find information available on a publication system may perform on a search of data repositories of such a system. The users then review the result and select listings of which they would like additional information.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIG. 2 is a block diagram of a searching subsystem that may be deployed within the system of FIG. 1 according to an example embodiment;

FIGS. 3-5 are example flowcharts illustrating a method for search request processing according to example embodiments;

FIG. 6 is an example flowchart illustrating a method for providing topical items according to an example embodiment;

FIG. 7 is an example graphical representation according to an example embodiment;

FIG. 8 is a network diagram depicting a network system, according to one embodiment, having a client server architecture configured for exchanging data over a network;

FIG. 9 is a block diagram illustrating an example embodiment of multiple network and marketplace applications, which are provided as part of the network-based marketplace; and

FIG. 10 is a block diagram diagrammatic representation of machine in the example form of a computer system within which a set of instructions for causing the machine to perform any one or more of the methodologies discussed herein may be executed.

### DETAILED DESCRIPTION

Example methods and systems for real-time data searches are described. In the following description, for purposes of explanation, numerous specific details are set forth in order to provide a thorough understanding of example embodiments. It will be evident, however, to one skilled in the art that the present invention may be practiced without these specific details.

In an example embodiment, time period news data may be received from a media source. A topical attribute associated with the time period news data may be obtained. A search request for data from a target data source may be received. The search request may include request criterion. The search request may be processed using the request criterion and the topical attribute to obtain result data. The result data may be provided from the target data source.

In an example embodiment, time period news data may be received from a media source. A plurality of topical attributes associated with the time period news data may be obtained. A graphical representation of the plurality of topical attributes may be provided. A portion of the graphical representation may be associated with a listing of a representative item for a particular topical attribute of the plurality of topical attribute.

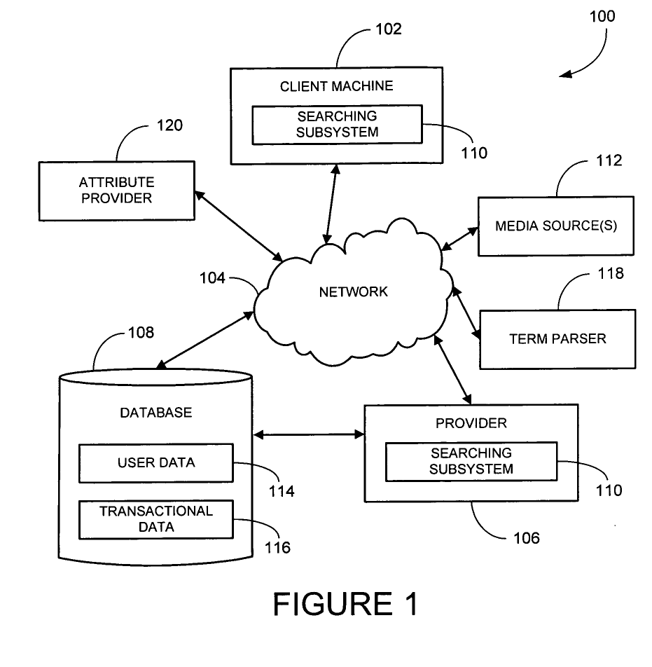

FIG. 1 illustrates an example system 100 in which a client machine 102 may be in communication with a provider 106 over a network 104. A user operating the client machine 102 may communicate with the provider 106 to conduct a search. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

A searching subsystem 110 may be deployed within the client machine 102 and/or the provider 106 to enable a user of the client machine 102 to search for item listings (e.g., a listing of goods or services) managed by the provider 106.

The provider 106 may also be in communication with a database 108. The database 108 may include user data 114 and/or transactional data 116. The user data 114 may include information regarding users of the provider. The transactional data 116 may include information regarding transactions conducted by the provider 106. For example, the sale of an item from one user to another may be stored in the transactional data 116.

A media source 112 may provide real-time data news including headline news. The real-time data news may be viewed on web pages provided by the media source 112 or may be otherwise viewed. In on embodiment, the real-time data news may be provided in a data feed (e.g., a RSS feed). Examples of the media sources 112 include cnn.com, yahoo.com, tmz.com, espn.com, and the like. The real-time data news and/or the headline news may be used by the client machine 102 and/or the provider 106, in one example embodiment, to provide listings based in part of the received information.

A term parser 118 may be used by the client machine 102 and/or the provider 106 to receive the real-time news data and provide the key terms associated with the real-time news data. In an example embodiment, the term parser 118 may be an application programmable interface (API) offered by Yahoo, Inc. However, other types of term parsers may also be used.

An attribute provider 120 may be used by the client machine 102 and/or the provider 106 to receive one or more topical attributes. The topical attributes may include the most popular new stories, the most popular videos, the most popular songs, or the like.

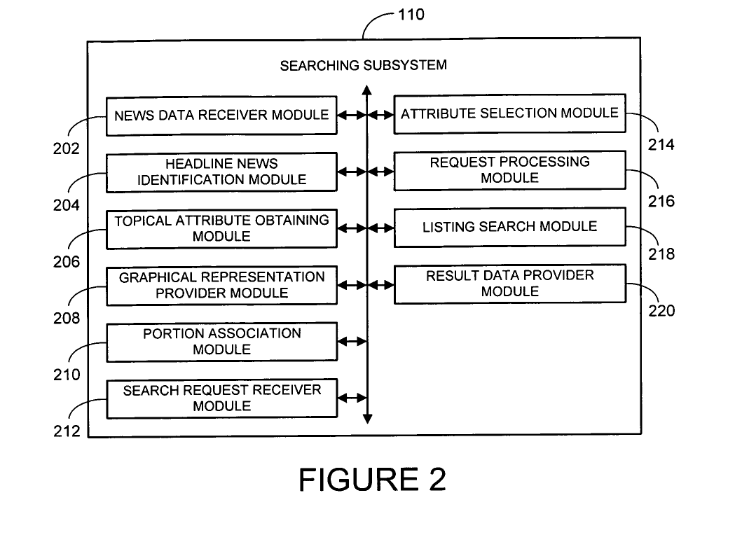

FIG. 2 illustrates an example searching subsystem 110 that may be deployed in the provider 106 of the system 100 (see FIG. 1) or otherwise deployed in another system. The searching subsystem may include a news data receiver module 202, a headline news identification module 204, a topical attribute obtaining module 206, a graphical representation provider module 208, a portion association module 210, a search request receiver module 212, an attribute selection module 214, a search request processing module 216, a listing search module 218, and/or a result data provider module 220. Other modules may also be included.

The news data receiver module 202 receives time period news data from the media source 112. The time period news data may include real-time news data, a designated time period news data, historical news data, or the like. The time period data may be received in a single category or in multiple categories from the media source 112. The time period news data may be received from the media source 112through a data feed or otherwise received. The headline news identification module 204 identifies headline news from the time period news data.

The topical attribute obtaining module 206 obtains one or more topical attributes associated with the time period news data. A topical attribute may be associated with a single category or multiple categories. The topical attribute may be obtained by receiving the topical attribute from the attribute provider 120. The topical attribute may be obtained by monitoring a number of user interactions associated with the time period news data and identifying the topical attribute responsive to the monitoring of the number of user interactions. The topical attribute may be obtained by obtaining a number of key terms associated with the time period news data and analyzing an occurrence frequency of the key terms to identify the topical attribute.

The graphical representation provider module 208 provides a graphical representation of the topical attribute and one or more additional tropical attributes. The portion association module 210 associates a portion of the graphical representation with the search request for the topical attribute and/or with a listing of a representative item for a particular topical attribute of the number of topical attribute.

The search request receiver module 212 receives a search request for data from a target data source. The search request may include request criterion. The request criterion may include the topical attribute. The attribute selection module 214 selects one or more popular topical attributes from the number of topical attributes.

The search request processing module 216 processes the search request using the request criterion and the topical attribute to obtain result data. The processing may include conducting a search using the request criterion and the topical attribute. The processing may include processing the search request using the request criterion and altering the result data of the processing of the search request based on the topical attribute. The processing of the search request may be based on selection of the one or more popular topical attributes.

The listing search module 218 searches for the listing of the representative item based on the particular topical attribute. The result data provider module 220 provides the result data from a target data source (e.g., the database 108).

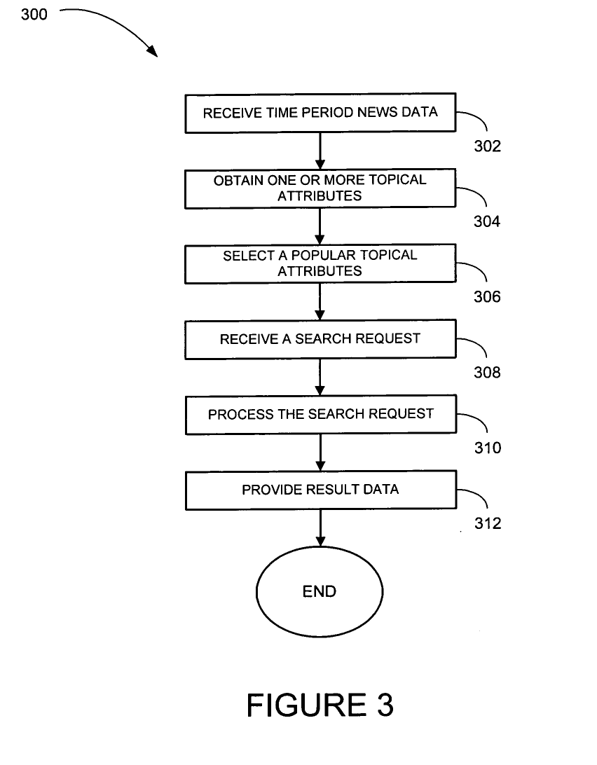

FIG. 3 illustrates a method 300 for search request processing according to an example embodiment. The method 300 may be performed by the provider 106 of the system 100 (see FIG. 1) or otherwise performed.

In an example embodiment, the method 300 may be used to process a search request using a requested term and a topical attribute. The method 300 may provide users with more relevant search results.

Time period news data is received from a media source at block 302. The time period data may be received in a single category (e.g., a particular category) or multiple categories (e.g., across a number of categories or general information) from the media source 112. The time period news data may include real-time news data, a designated time period news data (e.g., news from the last week, the last month, the last year), historical news data (e.g., from an archive), or the like. The time period news data may be received from the media source 112 through a data feed (e.g., a RSS feed) or may be otherwise received. The time period news data may include headline news or headline news may be identified from the time period news data.

One or more topical attributes associated with the time period news data are obtained at block 304. The topical attribute may be obtained from the attribute provider 120. The topical attribute may be obtained by monitoring a number of user interactions associated with the time period news data and identifying the topical attribute responsive to the monitoring of the number of user interactions. The user interactions may include click throughs, reviews, page views, message requests, or the like. The topical attribute may be associated with a single category or multiple categories. The topical attribute may be associated with the headline news or a different portion of the time period news data. One or more popular topical attributes may be selected from the available topical attributes at block 306.

A search request for data from a target data source is received at block 308. The search request may include request criterion. The search criterion may be a term, image data, video data, audio data, or the like. The search request is processed using the request criterion and the topical attribute to obtain result data at block 310. The processing of the search request may, in one embodiment, be based on selection of the one or more popular topical attributes.

The processing of the search request may include conducting a search using the request criterion and the topical attribute. The request criterion and the topical attribute may be given the same weight or different weights in conducting the search. The processing of the search request may include processing the search request using the request criterion and altering the result data of the processing of the search request based on the topical attribute.

In an example embodiment, the alteration of the result data may include altering a ranking of a number of listings of the result data based on the topical term or distinguishing one or more listings of the result data based on the topical attribute. For example, the distinguishing of the one or more listings may include highlighting the topical attribute in the one or more listings, providing an indicator in proximity to the one or more listings, or the like. The result data is provided from the target data source at block 312.

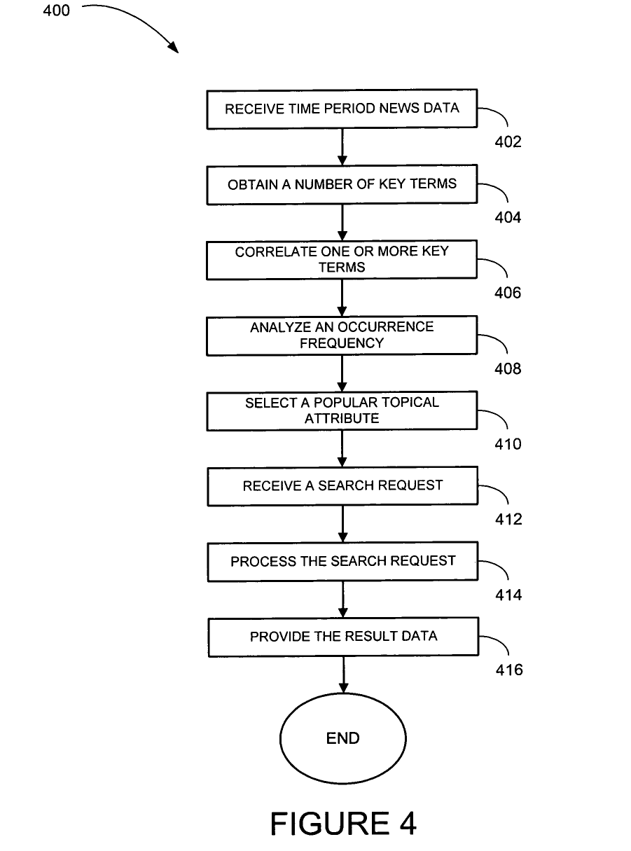

FIG. 4 illustrates a method 400 for search request processing according to an example embodiment. The method 400 may be performed by the provider 106 of the system 100 (see FIG. 1) or otherwise performed.

Time period news data is received from a media source at block 402. A number of key terms associated with the time period news data may be obtained at block 404. The key terms may be obtained by providing the time period news data to a term parser and receiving the key terms associated with the time period news data from the term parser 118. The key terms may be obtained by parsing the time period news data to identify the key terms associated with the time period news data.

One or more related terms from the key terms may be correlated at block 406. A particular related term of the key terms associated with at least one additional key term of the key terms. For example, the term “president” may be correlated with “ruler” and “leader”.

An occurrence frequency of the key terms may be analyzed to identify the topical attribute at block 408. The analysis of occurrence frequency of the key terms may be based on the correlation of the one or more related terms to identify the topical attribute. In an example embodiment, the operations performed at block 404, 406, and/or 408 may be used to obtain one or more topical attributes.

In an example embodiment, the analysis of the occurrence frequency of the key terms may be based on the correlation of the one or more related terms to identify the topical term. For example, an occurrence of “president” may also be counted as an occurrence of “ruler” and/or “leader”. The use of correlation may enable slightly different term usage among a number of stories to be appropriately accounted.

One or more popular topical attributes may be selected from the available topical attributes at block 410. A search request for data from a target data source (e.g., the database 108) is received at block 412. The search request may include request criterion. The search criterion may be a term, image data, video data, audio data, or the like.

The search request is processed using the request criterion and the topical attribute to obtain result data at block 414. The processing of the search request may, in one embodiment, be based on selection of the one or more popular topical attributes.

The processing of the search request may include conducting a search using the request criterion and the topical attribute. The request criterion and the topical attribute may be given the same weight or different weights in conducting the search. The processing of the search request may include processing the search request using the request criterion and altering the result data of the processing of the search request based on the topical attribute.

In an example embodiment, the altering of the result data may include altering a ranking of a number of listings of the result data based on the topical term or distinguishing one or more listings of the result data based on the topical attribute. For example, the distinguishing of the one or more listings may include highlighting the topical attribute in the one or more listings, providing an indicator in proximity to the one or more listings, or the like.

The result data is provided from the target data source at block 416.

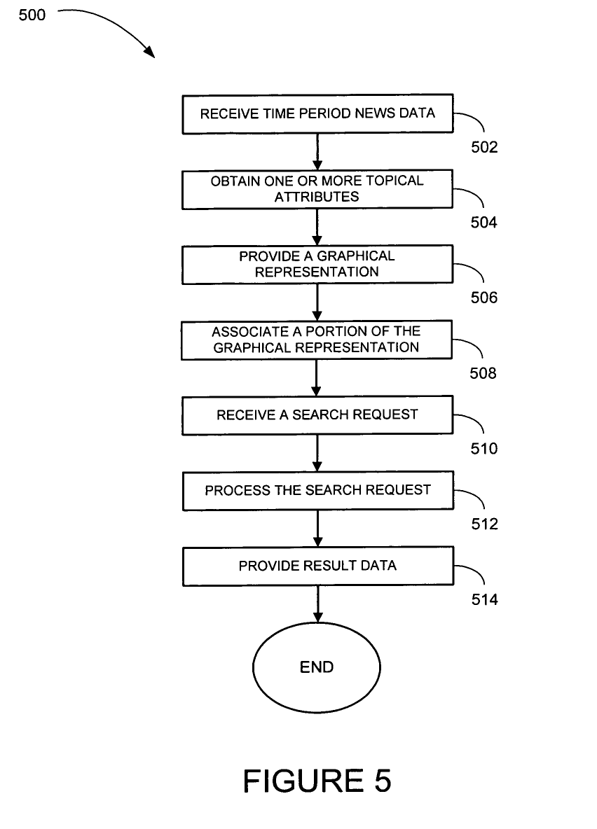

FIG. 5 illustrates a method 500 for search request processing according to an example embodiment. The method 500 may be performed by the provider 106 of the system 100 (see FIG. 1) or otherwise performed.

Time period news data is received from a media source at block 502. The time period data may be received in a single category (e.g., a particular category) or multiple categories from the media source 112. The time period news data may include real-time news data, a designated time period news data (e.g., news from the last week, the last month, the last year), historical news data (e.g., from an archive), or the like. The time period news data may be received from the media source 112 through a data feed (e.g., a RSS feed) or may be otherwise received. The time period news data may include headline news or headline news may be identified from the time period news data.

One or more topical attributes associated with the time period news data are obtained at block 504. The topical attribute may be obtained from the attribute provider 120. The topical attribute may be obtained by monitoring a number of user interactions associated with the time period news data and identifying the topical attribute responsive to the monitoring of the number of user interactions. The user interactions may include click throughs, reviews, page views, message requests, or the like. The topical attribute may be associated with a single category or multiple categories. The topical attribute may be associated with the headline news or a different portion of the time period news data.

A graphical representation of the topical attribute and one or more additional tropical attributes may be provided at block 506. At block 508, a portion of the graphical representation may be associated with a search request for the topical attribute. The graphical representation may include a single image or multiple images.

A search request for data from a target data source is received at block 510. The search request may include request criterion. The search criterion may be a term, image data, video data, audio data, or the like. The requested term may include the topical attribute.

The search request is processed using the request criterion and the topical attribute to obtain result data at block 512. The processing of the search request may, in one embodiment, be based on selection of the one or more popular topical attributes.

The processing of the search request may include conducting a search using the request criterion and the topical attribute. The request criterion and the topical attribute may be given the same weight or different weights in conducting the search. The processing of the search request may include processing the search request using the request criterion and altering the result data of the processing of the search request based on the topical attribute.

In an example embodiment, the altering of the result data may include altering a ranking of a number of listings of the result data based on the topical term or distinguishing one or more listings of the result data based on the topical attribute. For example, the distinguishing of the one or more listings may include highlighting the topical attribute in the one or more listings, providing an indicator in proximity to the one or more listings, or the like.

The result data is provided from the target data source at block 514.

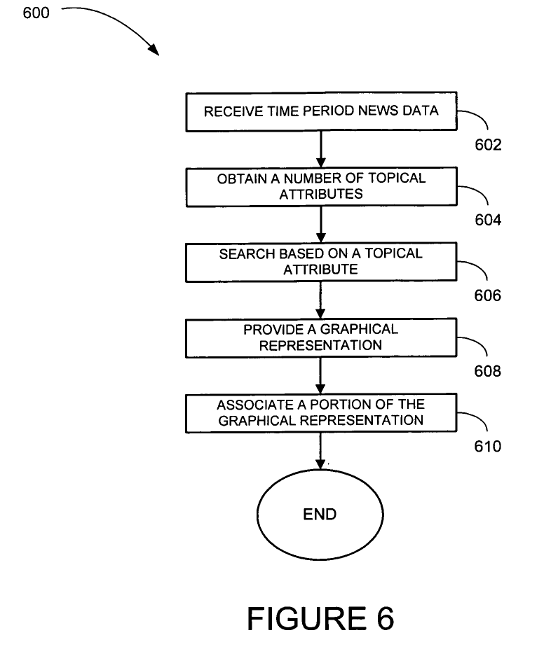

FIG. 6 illustrates a method 600 for providing topical items according to an example embodiment. The method 600 may be performed by the provider 106 of the system 100 (see FIG. 1) or otherwise performed.

Time period news data is received from the media source 112 at block 602. A number of topical attributes associated with the time period news data are obtained at block 604. The listing of the representative item may be searched based on the particular topical attribute at block 606.

A graphical representation of the topical attributes is provided at block 608. A portion of the graphical representation with a listing of a representative item for a particular topical attribute of the topical attributes is associated at block 610. The listing may be for a single representative item or multiple representative items (e.g., multiple of the same item or a variety of items associated with a same theme). In an example embodiment, the operations performed at block 606 may occur after the completion of the operations at block 610.

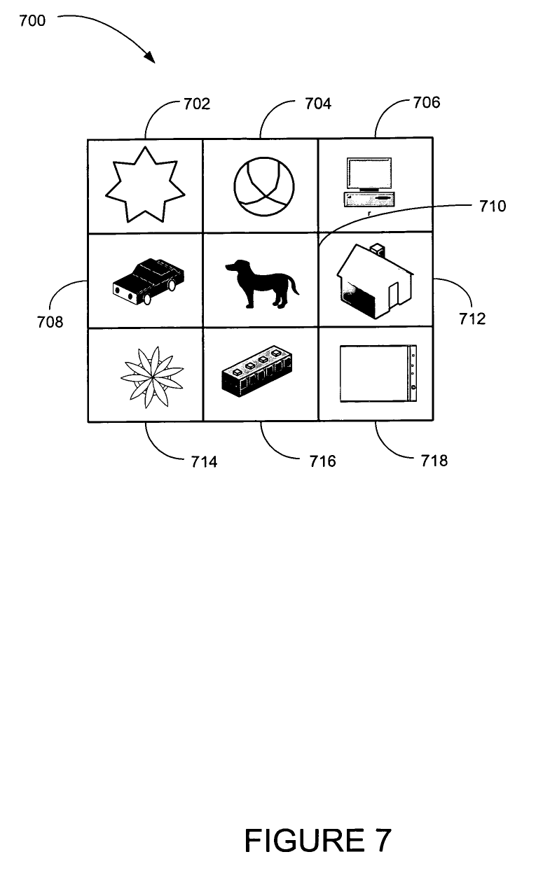

FIG. 7 illustrates a diagram of an example graphical representation 700 that may be provided to a user through a user interface. The graphical representation may be provided to a user during the operations at block 710, block 812, or otherwise provided.

The graphical representation 700 may include a number of portions 702-718. Each of the portions 702-718 may be associated with a listing of an item or a search request for an item. The portions may include a graphical representation that reflects the item.

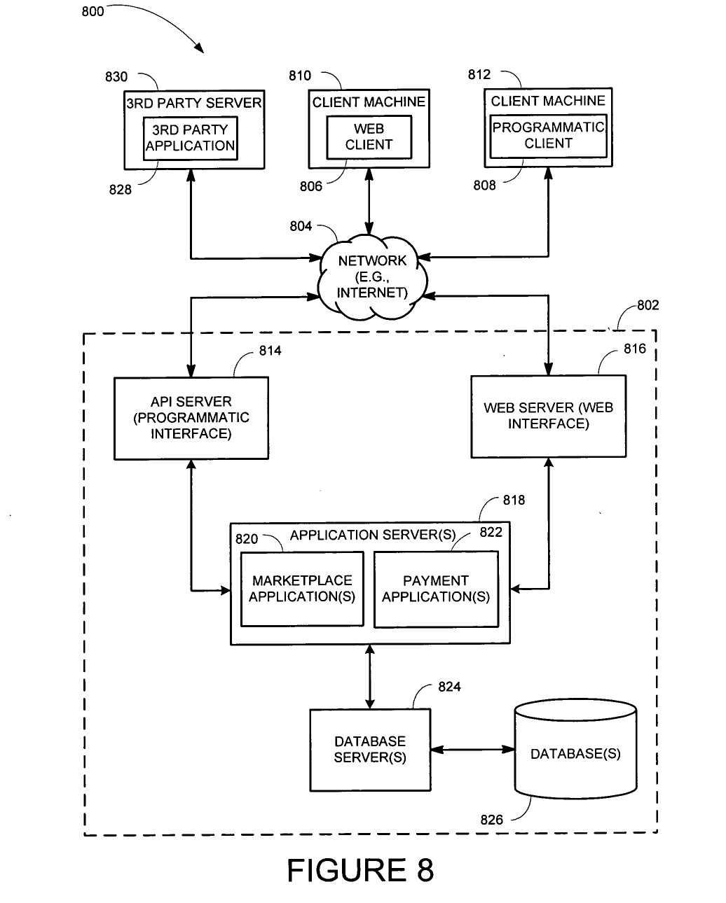

FIG. 8 is a network diagram depicting a client-server system 800, within which one example embodiment may be deployed. By way of example, a network 804 may include the functionality of the network 104, the provider 106 may be deployed within an application server 818, the media source 112 and/or the term parser 118 may be deployed on a third party server 830 as a third party application 828, and the client machine 812 may include the functionality of a client machine 810 or a client machine 812. The system 800 may also be deployed in other systems.

A networked system 802, in the example forms of a network-based marketplace or publication system, provides server-side functionality, via a network 804 (e.g., the Internet or Wide Area Network (WAN)) to one or more clients. FIG. 8 illustrates, for example, a web client 806 (e.g., a browser, such as the Internet Explorer browser developed by Microsoft Corporation of Redmond, Wash. State), and a programmatic client 808 executing on respective client machines 810 and 812.

An Application Program Interface (API) server 814 and a web server 816 are coupled to, and provide programmatic and web interfaces respectively to, one or more application servers 818. The application servers 818 host one or more marketplace applications 820 and authentication providers 822. The application servers 818 are, in turn, shown to be coupled to one or more databases servers 824 that facilitate access to one or more databases 826.

The marketplace applications 820 may provide a number of marketplace functions and services to users that access the networked system 802. The authentication providers 822 may likewise provide a number of payment services and functions to users. The authentication providers 822 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 820. While the marketplace and authentication providers 820 and 822 are shown in FIG. 8 to both form part of the networked system 802, in alternative embodiments the authentication providers 822 may form part of a payment service that is separate and distinct from the networked system 802.

Further, while the system 800 shown in FIG. 8 employs a client-server architecture, the present invention is of course not limited to such an architecture, and could equally well find application in a distributed, or peer-to-peer, architecture system, for example. The various marketplace and authentication providers 820 and 822 could also be implemented as standalone software programs, which need not have networking capabilities.

The web client 806 accesses the various marketplace and authentication providers 820 and 822 via the web interface supported by the web server 816. Similarly, the programmatic client 808 accesses the various services and functions provided by the marketplace and authentication providers 820 and 822 via the programmatic interface provided by the API server 814. The programmatic client 808 may, for example, be a seller application (e.g., the TurboLister™ application developed by eBay Inc., of San Jose, Calif.) to enable sellers to author and manage listings on the networked system 802 in an off-line manner, and to perform batch-mode communications between the programmatic client 808 and the networked system 802.

FIG. 8 also illustrates a third party application 828, executing on a third party server machine 830, as having programmatic access to the networked system 802 via the programmatic interface provided by the API server 814. For example, the third party application 828 may, utilizing information retrieved from the networked system 802, support one or more features or functions on a website hosted by the third party. The third party may, for example, provide one or more promotional, marketplace or payment functions that are supported by the relevant applications of the networked system 802.

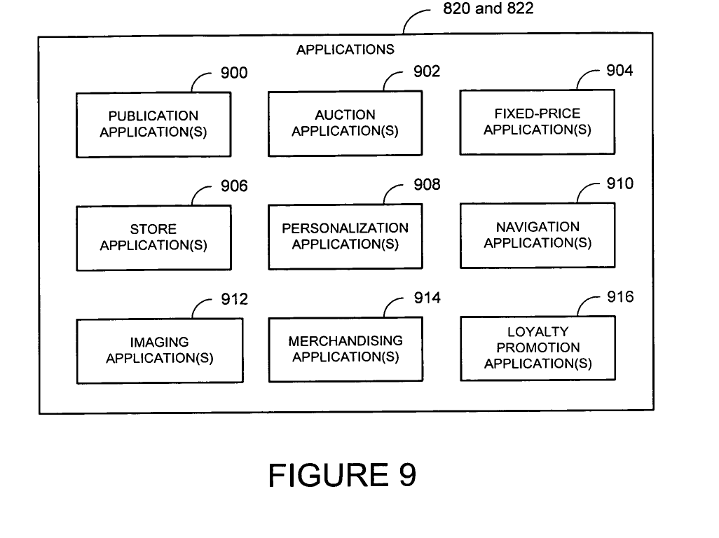

FIG. 9 is a block diagram illustrating multiple applications 820 and 822 that, in one example embodiment, are provided as part of the networked system 802 (see FIG. 8). The applications 820 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 826 via the database servers 824.

The networked system 802 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 820 are shown to include at least one publication application 900 and one or more auction applications 902 which support auction-format listing and price setting mechanisms (e.g., English, Dutch, Vickrey, Chinese, Double, Reverse auctions etc.). The various auction applications 902 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 904 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 906 allow a seller to group listings within a “virtual” store, which may be branded and otherwise personalized by and for the seller. Such a virtual store may also offer promotions, incentives and features that are specific and personalized to a relevant seller. For example, a store may modify its listings (e.g., an order of the listings or by offering particular items on sale) based on topical attributes.

Personalization applications 908 allow users of the networked system 802 to personalize various aspects of their interactions with the networked system 802. For example a user may, utilizing an appropriate personalization application 908, create a personalized reference page at which information regarding transactions to which the user is (or has been) a party may be viewed. Further, a personalization application 908 may enable a user to personalize listings and other aspects of their interactions with the networked system 802 and other parties. The personalization application 908 may use a topical attribute to provide more relevant results to the user.

Navigation of the networked system 802 may be facilitated by one or more navigation applications 910. For example, a search application (as an example of a navigation application) may enable key word searches of listings published via the networked system 802. The searching performed by the search application or the results of the search application may be altered by a topical attribute. A browse application may allow users to browse various category, catalogue, or system inventory structures according to which listings may be classified within the networked system 802. Various other navigation applications may be provided to supplement the search and browsing applications.

In order to make listings available via the networked system 802 as visually informing and attractive as possible, the marketplace applications 820 may include one or more imaging applications 912 utilizing which users may upload images for inclusion within listings. An imaging application 912 also operates to incorporate images within viewed listings. The imaging applications 912 may also support one or more promotional features, such as image galleries that are presented to potential buyers. For example, sellers may pay an additional fee to have an image included within a gallery of images for promoted items. An image may be selected based on a topical attribute.

Merchandising applications 914 support various merchandising functions that are made available to sellers to enable sellers to increase sales via the networked system 802. The merchandising applications 914 also operate the various merchandising features that may be invoked by sellers, and may monitor and track the success of merchandising strategies employed by sellers. The merchandising applications 914 may determine whether the merchandising efforts are affected by altering of the searching by a topical attribute.

The networked system 802 itself, or one or more parties that transact via the networked system 802, may operate loyalty programs that are supported by one or more loyalty/promotions applications 916. For example, a buyer may earn loyalty or promotions points for each transaction established and/or concluded with a particular seller, and may be offered a reward for which accumulated loyalty points can be redeemed. The loyalty/promotions applications 916 may, in one embodiment, provided enhanced earnings to users that search and/or make purchases on items that are associated with a topical attribute.

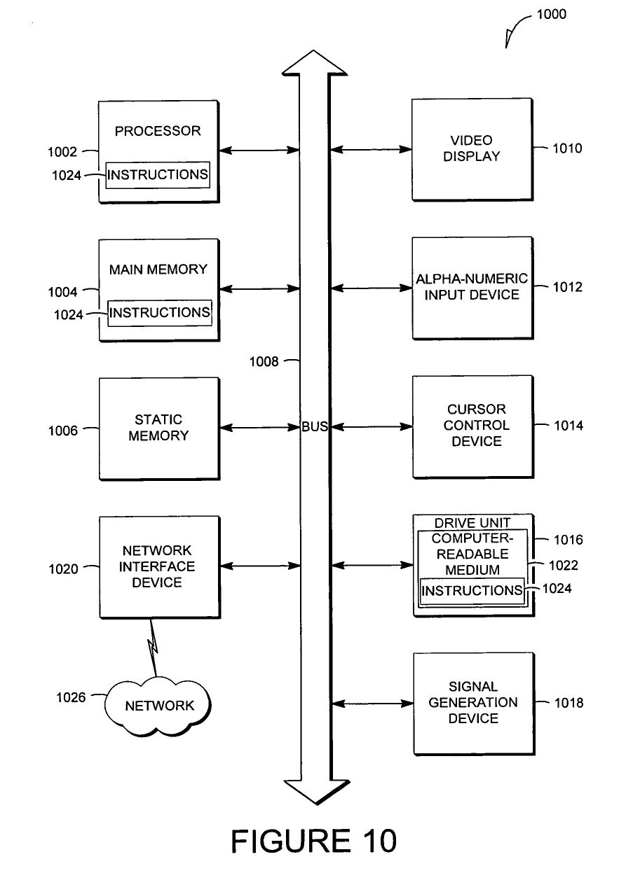

FIG. 10 shows a diagrammatic representation of machine in the example form of a computer system 1000 within which a set of instructions may be executed causing the machine to perform any one or more of the methods, processes, operations, or methodologies discussed herein. The provider 106, the media source 112, the term parser 118, and/or the attribute provider 120 may operate on or more computer systems 1000. The client machine 102 may include the functionality of one or more computer systems 1000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for real-time data searches have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving time period news data from a media source;
obtaining a topical attribute associated with the time period news data;
receiving a search request for data from a target data source, the search request including request criterion;
processing the search request using the request criterion and the topical attribute to obtain result data; and
providing the result data from the target data source.

2. The method of claim 1, wherein the processing of the search request comprises:
conducting a search using the request criterion and the topical attribute.

3. The method of claim 1, wherein the processing of the search request comprises:
processing the search request using the request criterion; and
altering the result data of the processing of the search request based on the topical attribute.

4. The method of claim 3, wherein the altering of the result data comprises:
altering a ranking of a plurality of listings of the result data based on the topical term.

5. The method of claim 3, wherein the altering of the result comprises:
distinguishing one or more listings of the result data based on the topical attribute.

6. The method of claim 5, wherein the distinguishing of the one or more listings includes at least one of:
highlighting the topical attribute in the one or more listings,
providing an indicator in proximity to the one or more listings, or combinations thereof.

7. The method of claim 1, wherein the obtaining of the topical attribute comprises:
receiving the topical attribute from an attribute provider.

8. The method of claim 1, wherein the obtaining of the topical attribute comprises:
monitoring a number of user interactions associated with the time period news data; and
identifying the topical attribute responsive to the monitoring of the number of user interactions.

9. The method of claim 8, wherein the user interactions include a click through, a review, a page view, a message request, or combinations thereof.

10. The method of claim 1, wherein the obtaining of the topical attribute comprises:
obtaining a plurality of key terms associated with the time period news data; and
analyzing an occurrence frequency of the plurality of key terms to identify the topical attribute.

11. The method of claim 10, wherein the obtaining of the plurality of key terms comprises:
providing the time period news data to a term parser; and
receiving the plurality of key terms associated with the time period news data from the term parser.

12. The method of claim 10, wherein the obtaining of the plurality of key terms comprises:
parsing the time period news data to identify the plurality of key terms associated with the time period news data

13. The method of claim 10, further comprising:
correlating one or more related terms from the plurality of key terms, a particular related term of the plurality of key terms associated with at least one additional key term of the plurality of key terms,
wherein the analyzing of occurrence frequency of the plurality of key terms is based on the correlating of the one or more related terms to identify the topical attribute.

14. The method of claim 1 including identification of a plurality of topical attributes, further comprising:
selecting one or more popular topical attributes from the plurality of topical attributes,
wherein the processing of the search request is based on selection of the one or more popular topical attributes.

15. The method of claim 1, wherein the receiving of the time period news data comprises:
receiving the time period data in a particular category from the media source,
wherein the topical attribute is associated with the particular category.

16. The method of claim 1, wherein the receiving of the time period news data comprises:
receiving the time period news data from the media source through a data feed.

17. The method of claim 1, further comprising:
identifying headline news from the time period news data,
wherein the topical attribute is associated with the headline news.

18. The method of claim 1, further comprising:
providing a graphical representation of the topical attribute and one or more additional tropical attributes; and
associating a portion of the graphical representation with the search request for the topical attribute,
wherein the request criterion includes the topical attribute.

19. The method of claim 1, wherein the time period news data includes real-time news data, a designated time period news data, historical news data, or combinations thereof.

20. A method comprising:
receiving time period news data from a media source;
obtaining a plurality of topical attributes associated with the time period news data;
providing a graphical representation of the plurality of topical attributes; and
associating a portion of the graphical representation with a listing of a representative item for a particular topical attribute of the plurality of topical attributes.

21. The method of claim 20, further comprising:
searching for the listing of the representative item based on the particular topical attribute.

22. A machine-readable medium comprising instructions, which when implemented by one or more processors perform the following operations: receiving time period news data from a media source;
obtain a topical attribute associated with the time period news data;
receive a search request for data from a target data source, the search request including request criterion;
process the search request using the request criterion and the topical attribute to obtain result data; and
provide the result data from the target data source.

23. The machine-readable medium of claim 22, wherein the one or more instructions to process the search request include:
conduct a search using the request criterion and the topical attribute.

24. The machine-readable medium of claim 22, wherein the one or more instructions to process the search request include:
process the search request for the request criterion; and
alter the result data of the processing of the search request based on the topical attribute.

25. A system comprising:
a real-time data receiver module to receive real-time news data from a media source;
a key term module to obtain a plurality of key terms associated with the real-time news data received from the real-time data receiver module;
an occurrence frequency analysis module to analyze an occurrence frequency of the plurality of key terms obtained from the key term module to identify a topical term;
a search request receiver module to receive a search request for an item based on a requested term;
a search request processing module to process the search request for the requested term based on the topical term obtained from the occurrence frequency analysis module; and
a result provider module to provide a result of one or more listings based on the processing of the search request by the search request processing module.
